(19) United States
(12) Patent Application Publication
(10) Pub. No.: US 2017/0070357 A1
(43) Pub. Date: Mar. 9, 2017

(54) WIRELESS COMMUNICATION DEVICE, WIRELESS COMMUNICATION SYSTEM, WIRELESS COMMUNICATION METHOD, AND NON-TRANSITORY COMPUTER READABLE MEDIUM

(71) Applicant: Kabushiki Kaisha Toshiba, Minato-ku (JP)

(72) Inventors: Fumiaki KANAYAMA, Kawasaki (JP); Hiroki KUDO, Kawasaki (JP); Ren SAKATA, Yokohama (JP); Yusuke DOI, Kawasaki (JP)

(73) Assignee: Kabushiki Kaisha Toshiba, Minato-ku (JP)

(21) Appl. No.: 15/257,083

(22) Filed: Sep. 6, 2016

(30) Foreign Application Priority Data
Sep. 7, 2015 (JP) 2015-175991

(51) Int. Cl. H04L 12/18; H04L 5/00; H04W 4/00

(52) U.S. Cl. CPC H04L 12/189; H04W 4/005; H04L 5/0055

(57) ABSTRACT

According to one embodiment, a wireless communication device includes: a receiver, processing circuitry and a transmitter. The receiver receives a first frame having first to M-th destination ID fields related to first to M-th data selection conditions and a data field, the data field including first to N-th data related to first to N-th wireless communication devices wherein M is an integer equal to or greater than 2 and N is an integer equal to or greater than 1. The processing circuitry selects at least one of the first to N-th data based on the data selection condition related to the destination ID field including an identifier of the self-wireless communication device among the first to M-th destination ID fields. The processing circuitry creates a second frame having a data field including the data selected. The transmitter transmits the second frame.

### CROSS-REFERENCE TO RELATED APPLICATIONS

This application is based upon and claims the benefit of priority from Japanese Patent Application No. 2015-175991, filed Sep. 7, 2015; the entire contents of which are incorporated herein by reference.

### FIELD Embodiments described herein relate to a wireless communication device, a wireless communication system, a wireless communication method, and a non-transitory computer readable medium.

### BACKGROUND

A wireless multi-hop network using a plurality of sensor nodes is known. The sensor nodes have wireless communication functions, and sensor data acquired by each sensor node is relayed by wireless communication and aggregated to a concentrator (aggregator). Some of the sensor nodes are operated by using batteries or energy harvesting as power supplies. Therefore, power saving of nodes, high reliability of communication, and band saving of occupied wireless band need to be satisfied at the same time. Using intermittent communication is effective in realizing the power saving. When the intermittent communication is used, making a transmission route redundant is more suitable than using acknowledgement (ACK) and retransmission in order to improve the reliability of transmission. In a well-known technique, the power saving is not taken into account, and the wireless band becomes tight due to an excessively redundant route. In another well-known technique, a specific method of making the transmission route from the nodes to the concentrator redundant is not disclosed.

### BRIEF DESCRIPTION OF THE DRAWINGS

FIG. 1 is a diagram showing a wireless multi-hop network including a wireless communication system according to a first embodiment;

FIG. 2 is a diagram showing an example of a form of network of the wireless multi-hop network;

FIG. 3 is a diagram showing an example in which each node transmits data in a time slot of the node based on TDMA;

FIG. 4 is a diagram showing an example of operation of a single route transmission scheme;

FIG. 5 is a diagram showing an example of transmission of a flooding scheme;

FIG. 6 is a diagram showing an example of configuration of a wireless communication device according to the first embodiment;

FIG. 7 shows an example of frames transmitted by a plurality of nodes;

FIG. 8 is a diagram showing a flow of data transmitted in the wireless multi-hop network in which a route is duplicated;

FIG. 9 is a diagram in which description of data discarded (not forwarded) by receiver nodes in FIG. 8 is omitted;

FIG. 10 is a diagram for describing transmission reliability;

FIG. 11 is a diagram showing an example of transmission success probability;

FIG. 12 is a diagram for describing an occupied band;

FIG. 13 is a block diagram showing an example of a hardware configuration of the wireless communication device according to the first embodiment;

FIG. 14 is a flow chart of operation of the wireless communication device according to the first embodiment;

FIG. 15 is a block diagram showing an example of a hardware configuration of a concentrator;

FIG. 16 is a diagram showing an example of a wireless multi-hop network according to a second embodiment;

FIG. 17 is a diagram showing another example of frames transmitted by a plurality of nodes;

FIG. 18 shows another example of data transmission in the wireless multi-hop network according to the second embodiment;

FIG. 19 is a diagram showing yet another example of data transmission in the wireless multi-hop network according to the second embodiment; and

FIG. 20 is a diagram showing an example in which a sub-concentrator is arranged in the wireless multi-hop network along with the concentrator.

### DETAILED DESCRIPTION

According to one embodiment, a wireless communication device includes: a receiver, processing circuitry and a transmitter. The receiver receives a first frame having first to M-th destination ID fields related to first to M-th data selection conditions and a data field, the data field including first to N-th data related to first to N-th wireless communication devices wherein M is an integer equal to or greater than 2 and N is an integer equal to or greater than 1. The processing circuitry selects at least one of the first to N-th data based on the data selection condition related to the destination ID field including an identifier of the self-wireless communication device among the first to M-th destination ID fields. The processing circuitry creates a second frame having a data field including the data selected. The transmitter transmits the second frame.

Embodiments of the present invention will now be described with reference to the drawings. The embodiments may be applied, as one example, for a system in which a relay node receives one or more packets during a certain period of time, constructs one aggregated packet by aggregating the received packets (or by aggregating data included in the received packets) and transmits the aggregated packet as relay data.

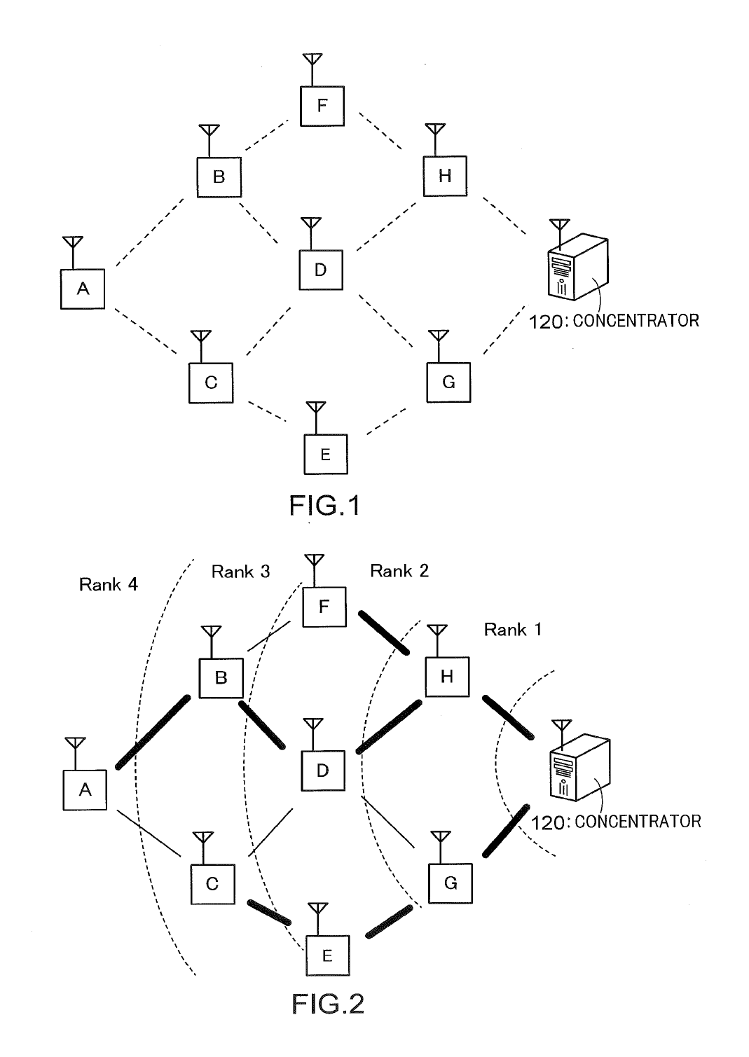

FIG. 1 shows a wireless multi-hop network including a wireless communication system according to the present embodiment. The network includes a plurality of wireless communication devices A, B, C, D, E, F, G, and H and a concentrator (aggregator) 120. The plurality of wireless communication devices aggregate data to the concentrator by multi-hop (method of transmitting data like bucket brigade). Each of the plurality of wireless communication devices includes a sensor configured to measure temperature, humidity, and the like and is called a sensor node (hereinafter, called a “node”). Data including sensor data acquired by the sensor of each node is aggregated to the concentrator. However, the node does not have to include the sensor, and the node can be operated as a relay node configured to only relay data received from other nodes.

FIG. 2 shows an example of a form of network of the present network. In the simulated form of network, the data is gradually uploaded by multi-hop from the nodes far from the concentrator.

Dotted lines in FIG. 2 divide the plurality of nodes into a plurality of ranks. The plurality of nodes are divided into ranks 1 to 4 here. The nodes capable of directly communicating with the concentrator will be expressed as nodes of the rank 1. The nodes capable of directly communicating with the nodes of the rank 1 will be expressed as nodes of the rank 2. For example, the nodes G and H belong to the rank 1, and the node D belongs to the rank 2.

The nodes are expressed in the same way for the rank 3 and subsequent ranks. More specifically, the nodes capable of directly communicating with the nodes of the rank 2 will be expressed as nodes of the rank 3, and the nodes capable of directly communicating with the nodes of the rank 3 will be expressed as nodes of the rank 4. The concentrator will be expressed as a node of a rank 0 in some cases.

In general, a radio wave is attenuated with an increase in the propagation distance, and wireless communication cannot be performed between wireless communication devices (nodes) more than a certain distance apart. In the illustrated example, the wireless communication devices capable of directly communicating with the concentrator are only the nodes G and H, and the node D cannot directly communicate with the concentrator. However, the nodes D and G can perform wireless communication, and the data of the node D can be transferred to the concentrator if the node G relays the data transmitted by the node D.

The magnitude of the ranks is expressed higher or lower in some cases, and it is expressed that the nodes of the rank 1 are higher than the nodes of the rank 2.

A node capable of directly wirelessly communicating with another node will be expressed as a neighboring node. For example, neighboring nodes of the node H are the node F, the node D, and the concentrator.

In the present embodiment, the nodes are basically not designed to communicate with the nodes of the same rank, and therefore, other nodes belonging to the same rank as a node will not be called neighboring nodes of the node. However, wireless communication may be performed between the nodes belonging to the same rank.

Among the neighboring nodes, a neighboring node with a higher rank than a node (capable of communicating with the concentrator by a small number of hops) will be expressed as a higher neighboring node, and a neighboring node with a lower rank than the node will be expressed as a lower neighboring node.

Each node includes a unique identifier (ID) in the network. In the drawings, the identifiers of the nodes A to H are “A” to “H”. The identifier may be any value that allows uniquely identifying the node in the network. For example, the identifier may be allocated by a used application or may be an address used in a wireless communication protocol. The identifier may be other types. The sensor data measured by the nodes A to H will be expressed as sensor data “a” to “h”.

In FIG. 2, solid lines connecting the nodes include thick solid lines and thin solid lines. The thick solid lines denote paths in which transmitter nodes forward all of the data received from the lower neighboring nodes, and the thin solid lines denote paths in which the transmitter nodes forward part of the received data (for example, only data acquired based on the sensor of a transmission source among the received data). Details will be described later.

A TDMA (Time Division Multiple Access) scheme is used as a communication scheme of the present network, and a network protocol based on the TDMA is applied. In the multi-hop network that requires power saving, the TDMA scheme in which a transmitter node (transmission node) and a receiver node (reception node) can synchronize to carry out “sleep” and “awake” to secure a longer sleep time is more suitable than a CSMA (Carrier Sense Multiple Access)-based scheme in which the reception node always has to wait for the reception. The TDMA scheme is also suitable for realizing a real time property. In the present embodiment, the TDMA scheme can be used to secure the sleep time when the node does not perform the transmission and reception, and the real time property can also be realized at the same time.

A radio wave output by another system may exist near the node, and the radio wave may interfere with the node in the present network. Therefore, a method such as CSMA/CA

(Collision Avoidance) may be combined in individual time-division slots. For example, carrier sense may be performed for a certain time at the start of individual time-division slots, and the transmission may be performed after checking that there is no interference radio wave.

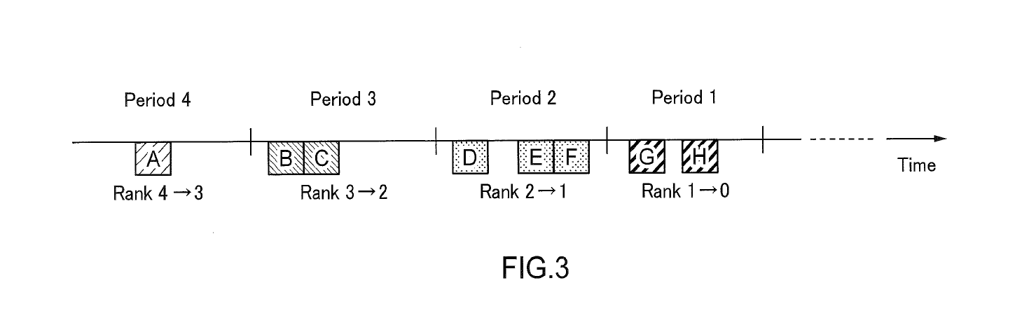

FIG. 3 shows an example in which each node transmits the data in a time slot of the node based on the TDMA. Provided are a period (“Period”) 4 in which a node of the rank (“Rank”) 4 transmits data to a node of the rank 3, a period 3 in which a node of the rank 3 transmits data to a node of the rank 2, a period 2 in which a node of the rank 2 transmits data to a node of the rank 1, and a period 1 in which a node of the rank 1 transmits data to a node (concentrator) of the rank 0.

In the periods 1 to 4, time slots are allocated to the nodes belonging to corresponding ranks. Setting of the periods (arrangement, length, cycle, and the like) and the allocation of the time slots may be determined by collaboration between the nodes. There may be a separate manager configured to manage the setting of the periods and the allocation of the time slots, and the manager may set the periods and allocate the time slots. The concentrator may serve as the manager. When there is a manager, the nodes that cannot directly communicate with the manager can use the relay between the nodes to communicate with the manager.

The periods 1 to 4 are repeated at a certain cycle. Each node transmits the data in the allocated time slot of the period that the node belongs. The node internally accumulates the data received from other nodes until the start of the time slot. The node generates a frame for forwarding the accumulated data according to the start of the time slot and transmits the data in the time slot. A generation method of the frame will be described later.

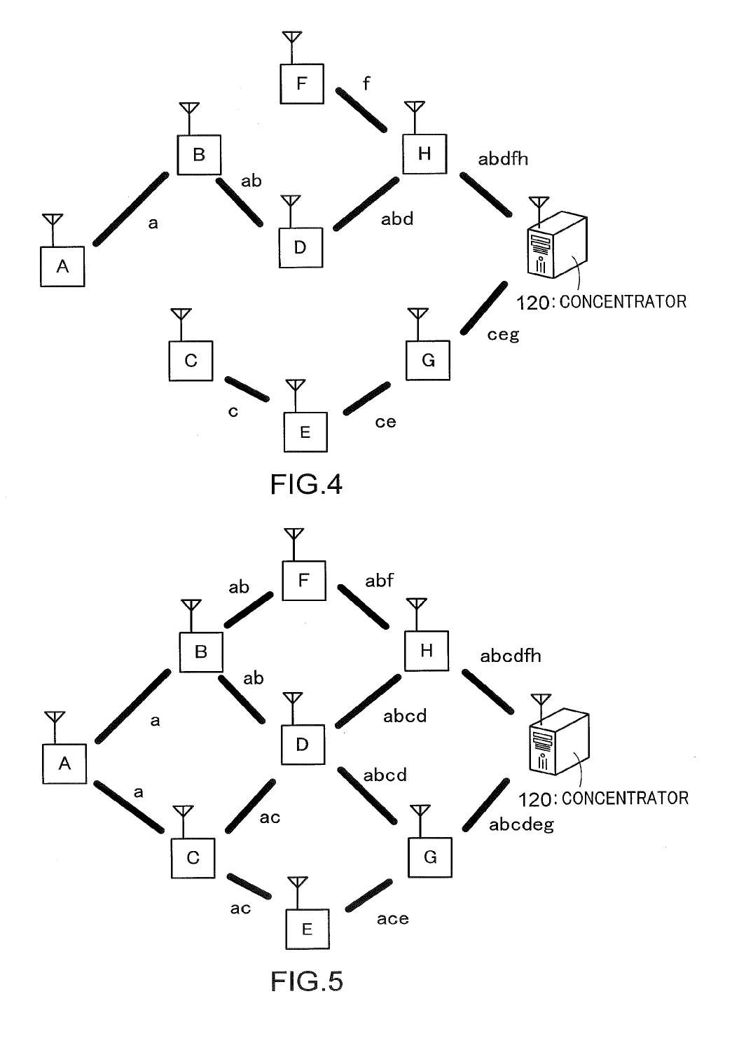

Forms of transmission in the multi-hop wireless network will be described. One of the simplest forms of transmission is a single route transmission scheme. In this scheme, tree-shaped transmission routes are constructed in the network, and each node adds the data received from the transmission node and the data of the node to the frame and transmits the frame to a single reception node. FIG. 4 shows an example of operation of the single route transmission scheme. A lower case alphabet added to the side of a solid line connecting nodes indicates the data transmitted between the nodes. For example, “a” is the data of the node A. Although the single route transmission scheme is advantageous in that an occupied wireless communication band is small, reliability of communication is low. For example, if the node D fails to communicate with the node H, not only the data of the node D, but also the data of the nodes A and B that are nodes below the node D are lost.

When the reliability of the single route transmission is a problem, examples of measures for improving the reliability include the following.
1. Use ACK or NACK to check whether the transmission is successful, and retransmit the data.
2. Repeat transmitting the data for a plurality of times without using ACK or NACK.
3. Use an error correction code to recover part of missing data.
4. Use a plurality of transmission routes for multiplex transmission (route diversity).

An example of the simplest multiplexing of transmission routes in the measure 4 includes a flooding scheme. FIG. 5 shows an example of transmission in the flooding scheme. The wireless communication device (node) adds all of the data received from the transmission node and the data of the node to the frame and transmits the frame to a plurality of reception nodes. As a result, the data of each node is multiplexed, and the reliability improves. For example, the data “a” of the node A is relayed by all of the other nodes and reaches the concentrator 120. The route of the data “a” is maximum in the nodes of the rank 2 (D, E, and F), and the route is triplicated in this case. Although the scheme significantly improves the reliability of the transmission, the scheme is disadvantageous in that the wireless communication band is squeezed with an increase in the amount of transmission data. The number of nodes is relatively small in the example of FIG. 5, and the occupation of the band is unlikely to be a problem. However, the amount of transmission data exponentially becomes large relative to the number of nodes, and the band becomes a big problem if the number of nodes increases to several dozen or several hundred.

In the present embodiment, the transmission route of the frame is multiplexed (duplicated in the present embodiment), and data selection conditions are set in the frame according to the destination nodes in order to solve the problems of the single route transmission and the flooding transmission. In each node, data to be forwarded is selected from the data included in the received frame based on the data selection conditions. The selected data and the data of the node are added to the frame, and the frame is transmitted. In this way, the problems of the single route transmission and the flooding transmission are solved, and both of the transmission reliability and the saving of the wireless band are attained.

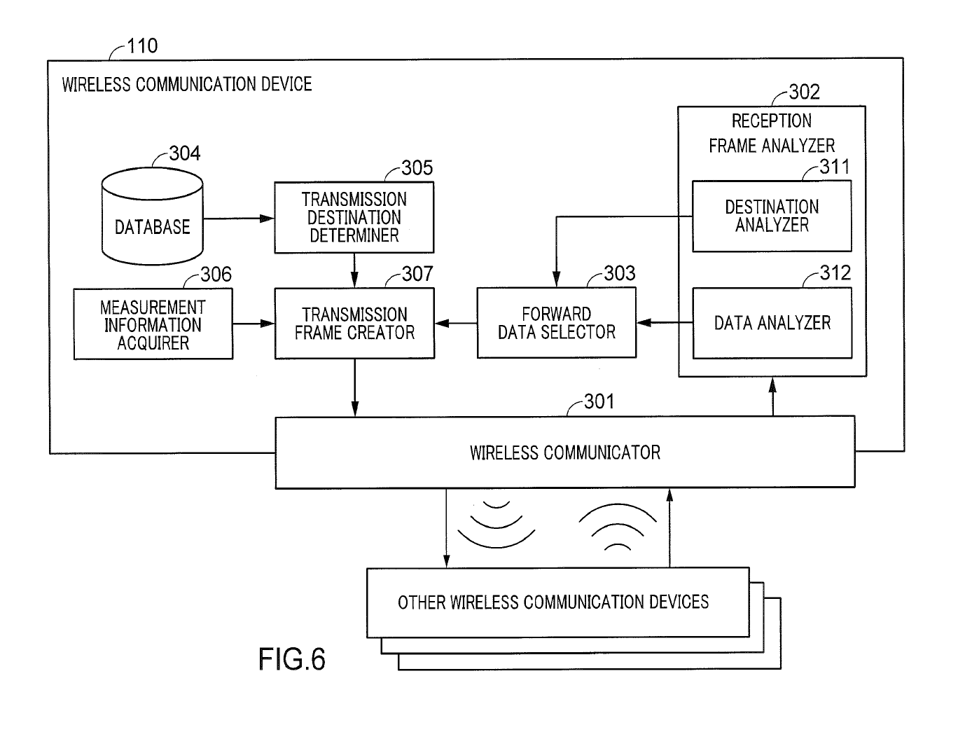

FIG. 6 shows an example of a configuration of a wireless communication device (node) 110 according to the present embodiment. Each of the nodes A to H shown in FIGS. 1 to 5 has the configuration of FIG. 6. The wireless communication device 110 includes a wireless communicator 301, a reception frame analyzer 302, a forward data selector (selector) 303, a database 304, a transmission destination determiner 305, a measurement information acquirer (acquirer) 306, and a transmission frame creator (frame creator) 307. As one example, processing circuitry according to the present embodiment may include the elements 302, 303, 305, 306 and 307. The “circuitry” may refer to not only electric circuits or a system of circuits used in a device but also a single electric circuit or a part of the single electric circuit.

The wireless communicator 301 transmits and receives frames through wireless communication with other nodes (wireless communication devices or concentrator). The wireless communicator 301 includes a receiver configured to receive frames and a transmitter configured to transmit frames. For example, the wireless communicator 301 executes processing of a data link layer, such as a MAC layer, and a PHY layer, DA conversion, AD conversion, and analog processing. Examples of the processing of the PHY layer include encoding/decoding and modulation/demodulation. The analog processing includes frequency conversion between baseband and wireless frequency, band control, amplification processing, and the like. When a communication protocol such as TCP/IP is used in the communication between nodes, processing of TCP/IP may be executed by the wireless communicator 301 or may be executed by a separately arranged CPU. Although the wireless communication scheme is not limited to specific schemes, examples of the scheme that can be used include IEEE 802.15.4 and Zigbee.

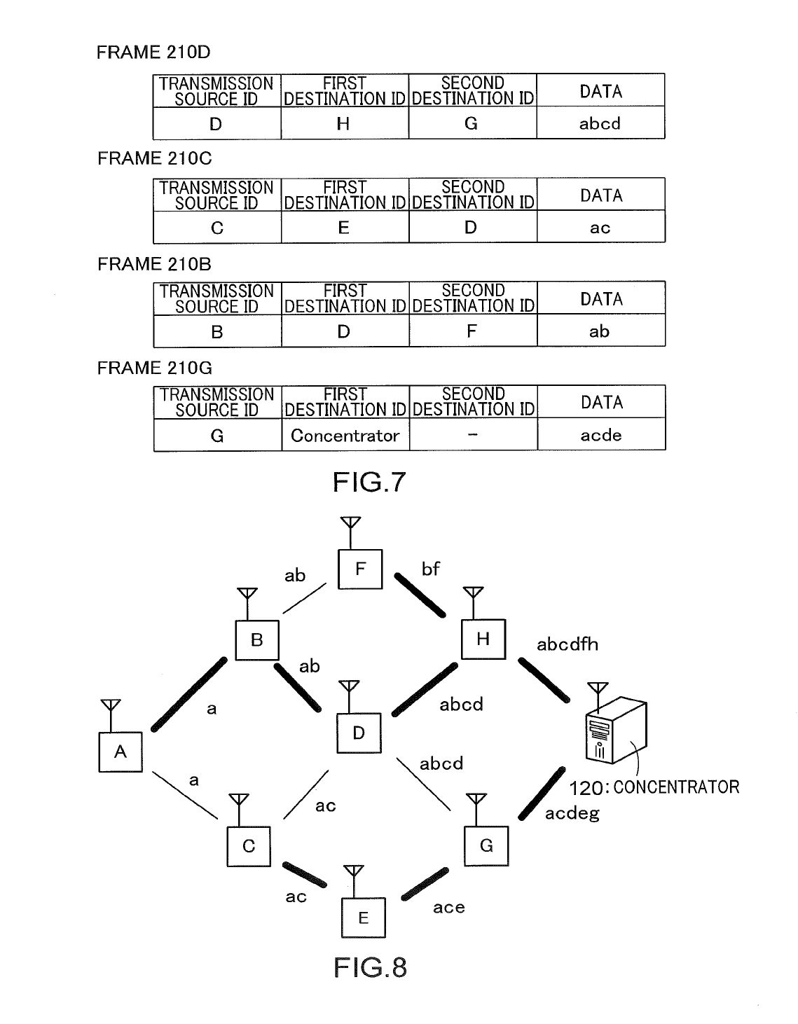

The reception frame analyzer 302 analyzes the frames received by the wireless communicator 301. As shown in FIG. 7 described later, the frame includes a transmission source ID field, a first destination ID field, a second destination ID field, and a data field. The transmission source ID field, the first destination ID field, and the second destination ID field correspond to a header, and the data field corresponds to a payload, for example.

The identifier (ID) of the node of the transmission source is set in the transmission source ID field. The identifiers of the nodes or the concentrator as transmission destinations are set in the first destination ID field and the second destination ID field. Data related to one or a plurality of nodes is set in the data field. For example, the sensor data and the identifier of the node are included in the data while being associated each other.

A first data selection condition and a second data selection condition indicating a method of selecting data to be forwarded from the data included in the data field are associated in the first destination ID field and the second destination ID field. Although the first data selection condition is associated in the first destination ID field, and the second data selection condition is associated in the second destination ID field here, the association between the data selection conditions and the destination ID fields may be arbitrary. For example, the second data selection condition may be associated in the first destination ID field, and the first data selection condition may be associated in the second destination ID field. Although the data selection condition is associated at the position of the destination ID field here, an example of modification includes a modification in which a field for storing information explicitly indicating the data selection condition is added to each destination ID field, and a value identifying the data selection condition is set in the field. Details of a setting method of the first destination ID field, the second destination ID field, and the data field will be described later.

The fields (transmission source ID field, first destination ID field, second destination ID field, and data field) are, for example, messages of an application in a layer upper than the MAC layer. However, the present embodiment is not limited to this. For example, the first destination ID field and the second destination ID field may be fields in the header of the MAC layer. In this case, the first destination ID field and the second destination ID field may correspond to a reception destination address field and a transmission source address field in the header of the MAC layer.

The reception frame analyzer 302 includes a destination analyzer 311 and a data analyzer 312.

The destination analyzer 311 analyzes the first destination ID field and the second destination ID field of the received frame. The destination analyzer 311 figures out the correspondence between the wireless communication device including the identifier set in the first destination ID field (i.e. node designated in the first destination ID field) and the data selection condition associated in the first destination ID field (first data selection condition here). The destination analyzer 311 figures out the correspondence between the wireless communication device including the identifier set in the second destination ID field (i.e. node designated in the second destination ID field) and the data selection condition associated in the second destination ID field (second data selection condition here). The data analyzer 312 analyzes the data field of the frame to figure out the data of one or a plurality of nodes set in the data field. When the data includes the sensor data, the identifier of the node, and the like, the data analyzer 312 can analyze the identifier included in the data to determine the node that the data belongs.

Based on the information obtained by the analysis by the reception frame analyzer 302, the forward data selector 303 selects the data to be forwarded by the device from the data included in the received frame.

For example, when the node is designated in the first destination ID field, the first data selection condition is applied, and the forward data selector 303 selects all of the data included in the data field. More specifically, the first data selection condition requests to select all of the data included in the data field. When the node is designated in the second destination ID field, the forward data selector 303 selects only data of the node designated in the transmission source ID field (transmission source data) from the data included in the data field. More specifically, the second data selection condition requests to select the data of the node designated in the transmission source ID field (transmission source node) from the data included in the data field. Note that data selection conditions other than the first and second data selection conditions may be defined.

The database 304 holds information related to the higher neighboring node of the node. For example, the database 304 holds information related to the identifier of the higher neighboring node and a radio wave condition between the node and the higher neighboring node. The database 304 is stored in, for example, a storage device such as a memory and a storage.

Based on the database 304, the transmission destination determiner 305 determines the destinations for transmitting the data selected by the forward data selector 303. More specifically, the transmission destination determiner 305 determines the identifiers to be set in the first destination ID field and the second destination ID field of the frame created by the transmission frame creator 307. The node or the concentrator with the identifier set in the first destination ID field related to the first data selection condition is called a first destination, and the node or the concentrator with the identifier set in the second destination ID field related to the second data selection condition is called a second destination. However, a value is not set in the second destination ID field in some cases, and “ANY” indicating an arbitrary node is set in some cases.

The measurement information acquirer 306 acquires the sensor data from the sensor included in the node. The type of the sensor may be any type. The sensor may measure the temperature, the humidity, or the like. If a battery is to be sensed, the sensor may measure an amount of charge. If a living body is to be sensed, the sensor may measure a state of the living body such as pulse and acceleration. The measurement information acquirer 306 may directly acquire the sensor data from the sensor or may read the sensor data from a storage device, such as a memory and a storage, after storing the sensor data in the storage device. The data to be acquired is not limited to the sensor data, and the data may be data other than the sensor data, such as information related to malfunction or integrity and link quality information between the node and the neighboring nodes. When the node can be connected to another wireless network, the data may be information acquired from the wireless network. In the case described below, the measurement information acquirer 306 acquires the sensor data.

The transmission frame creator 307 generates a payload based on the data associating the sensor data acquired by the measurement information acquirer 306 and the identifier of the node and based on the data selected by the forward data selector 303 and sets the payload in the data field. The transmission frame creator 307 sets the first destination (identifier) and the second destination (identifier) determined by the transmission destination determiner 305 in the first destination ID and second destination ID fields and sets the identifier of the node in the transmission source ID field.

In this way, the transmission frame creator 307 creates a frame. As described, the frame is transmitted in the allocated time slot in the period repeated at a predetermined cycle in the TDMA. When a plurality of frames are received during the transmission cycle of the node, all of the data of the plurality of frames selected by the forward data selector 303 can be temporarily stored, and all of the data can be set in the data field

The wireless communicator 301 receives the frame created by the transmission frame creator 307 and wirelessly transmits the frame. In the actual transmission of the frame, the frame is transmitted after adding the MAC header, the PHY header, and the like to the message (frame) including the transmission source ID, the first destination ID, the second destination ID, and the data. The frame is transmitted by broadcast or multicast. In an example of a method of broadcasting or multicasting the frame, a broadcast address or a multicast address is used as the destination address of the MAC header. The transmitted frame reaches all of the neighboring nodes (higher neighboring nodes and lower neighboring nodes) of the node. Each of the nodes and the concentrator designated in the first destination ID field and the second destination ID field receives the frame (determines that the frame is addressed to the node or the concentrator). As a result, the transmission route of the frame is duplicated. Each node selects the data from the data included in the data field of the frame according to the data selection condition related to the destination ID field designating the node and forwards the selected data again.

The method of transmitting the data by broadcast or multicast is not limited to the method. For example, a method of using a group common key to encrypt the frame can also be used. Specifically, the group common key is shared by the first destination, the second destination, and the node, and the nodes other than the first destination and the second destination cannot decode the frame even if the nodes receive the frame. Therefore, the nodes other than the first destination and the second destination do not have to execute the process of determining whether the identifiers of the nodes are set in the destination ID fields of the frame. It can be stated that the transmission of the encrypted frame is broadcast or multicast transmission only between the nodes capable of decoding the frames.

The components in the block diagram of FIG. 6 are not essential, and part of the components can be omitted.

For example, the measurement information acquirer 306 can be omitted. In this case, the present wireless communication device operates as a relay node configured to only relay the multi-hop communication.

FIG. 7 shows an example of the frames transmitted by the plurality of nodes D, C, B, and G in the wireless multi-hop network of FIG. 2. The frame format of the frames includes the transmission source ID field, the first destination ID field, the second destination ID field, and the data field as described above. For example, the transmission source ID field, the first destination ID field, and the second destination ID field are equivalent to the header, and the data field is equivalent to the payload. Fields other than these may exist in the header and the payload.

An uppermost row of FIG. 7 shows a frame 210D transmitted by the node D. The header of the frame 210D includes the transmission source ID (D), the first destination (H), and the second destination (G), and the data field includes the data (abcd). Values in parentheses are values actually set. For example, the data “a” is the data of the node A. The data of the node A includes the sensor data and the identifier of the node A, for example. However, the identifier of the node A does not have to be included in the data “a” as long as the sensor data can be specified as data of the node A, i.e. as long as it can be specified that the sensor data is associated with the node A. For example, if an individual field dedicated to each node is set in the data field, the node can be identified from the position of the individual field. Therefore, the sensor data can be stored in the individual field without storing the identifier of the node.

The data “b” and “c” of the lower neighboring nodes B and C that the node D can directly communicate, the data “a” of the node A that is a lower node incapable of directly communicating with the node D, and the data “d” including the sensor data measured by the node are set in the data field of the frame 210D. In the transmission source ID field, “D” that is the identifier of the node is set.

In the first destination ID field, “H” that is the identifier of a higher neighboring node is set. In the second destination ID field, “G” that is the identifier of another higher neighboring node is set. The frame transmitted from the wireless communicator 301 is transmitted by broadcast or multicast as described above, and the frame reaches the nodes other than the nodes designated in the first destination ID field and the second destination ID field.

Frames 210C and 210B shown in an upper middle row and a lower middle row of FIG. 7 are frames transmitted from the nodes B and C, respectively. A frame 210G of a lowermost row is a frame transmitted from the node G. The node G can directly communicate with the concentrator. Therefore, the identifier of the concentrator is set in the first destination ID field, and nothing is designated in the second destination ID field

The frame format shown in FIG. 7 is an example, and fields other than the fields may be included. Part of the fields may be omitted. For example, a field designating the rank of the node may be added. In a system of performing communication by allocating a time slot or a frequency to each node, the transmission node can be identified from the used time slot or frequency. Therefore, the transmission source ID field can be omitted.

Operation when the wireless communication device (node) receives the frame will be described. The wireless communicator 301 of the node D receives the frames 210C and 210B of FIG. 7 from the nodes C and B. The reception frame analyzer 302 analyzes the frames 210c and 210B, and the forward data selector 303 selects the data to be forwarded.

The identifier (address) D of the node is set in the first destination ID field of the frame 210B received from the node B. In this case, all of the data (ab) set in the data field of the frame 210B is selected based on the first data selection condition related to the first destination ID address field in which the identifier of the node is set, and the data is added to the data field of the frame transmitted by the node. The identifier D of the node is set in the second destination ID field of the frame 210C received from the node C. In this case, only the data (c) of the node C that is the transmission source is selected from the data (ac) set in the data field of the frame 210C based on the second data selection condition related to the second destination ID address field in which the identifier of the node is set. The data is added to the data field of the frame transmitted by the node, and the data (a) of the other node is discarded. The data to be forward by the node D is determined to be “abc” through the operation. The data “d” of the node is further added, and the data to be transmitted from the node is “abcd”. Therefore, “abcd” (see uppermost row of FIG. 7) is set in the data field of the frame to be transmitted from the node. Note that “abcd” includes the data “a”, the data “b”, the data “c”, and the data “d”, and the data does not have to be arranged in this order.

According to the algorithm of the reception operation, if the frame 210B further includes other sensor data “x”, “x” is selected according to the first data selection condition, and “x” is added to the data field of the frame. If the frame 210C further includes other sensor data “y”, “y” is discarded according to the second data selection condition. Note that a node without the lower neighboring node is an end node in the lowest rank, and the node does not receive frames from lower nodes. Therefore, there is no data to be forwarded by the node. If a node receives a frame in which the node is not designated in one of the first destination ID field and the second destination ID field, the node discards the frame.

The operation of the transmission destination determiner 305 will be described in detail. The transmission destination determiner 305 acquires a list of the higher neighboring nodes and information of each higher neighboring node from the database 304 and determines the first destination and the second destination of the frame to be transmitted from the node. The first destination is a node for which the first data selection condition is applied, and the second destination is a node for which the second data selection condition is applied. The first destination and the second destination are determined based on, for example, the radio wave status between the node and the higher neighboring nodes. Specifically, nodes with suitable reception strengths of radio wave (such as RSSI (Received Signal Strength Indication)) between the node and the higher neighboring nodes are sequentially selected as the first destination and the second destination. The reception strength of radio wave may be a reception strength of a signal received by the node from the higher neighboring node. Alternatively, the higher neighboring node may measure the reception strength of the signal received from the node, and the value may be used by feeding back the value to the node. Alternatively, a statistic, such as an average value of these, may be used. The reception strength may be a value other than the RSSI.

To determine the first destination and the second destination, the transmission destination determiner 305 may take into account not only the radio wave status between the node and the higher neighboring nodes, but also the radio wave status of the route from the node to the concentrator. For example, for each route from the node to the concentrator, an integrated value of the RSSIs of the paths (routes between adjacent nodes) included in the route is calculated, and two routes with highest integrated values are selected from the routes. In descending order of the integrated values of the two routes, the higher adjacent nodes included in each route are determined as the first destination and the second destination. Alternatively, past transmission successful results of each route may be taken into account to determine the first destination and the second destination.

A phenomenon (hot spot) that the data is excessively concentrated on one node may occur around the concentrator, and the transmission route can be selected to avoid this.

The selection methods of the first destination and the second destination described here are just examples, and the algorithm of selecting the first destination and the second destination from the higher neighboring nodes can be any algorithm.

FIG. 8 shows flows of the data transmitted in the wireless multi-hop network in which the route is duplicated. Thick solid lines indicate flows of the data transmitted when the node is designated in the first destination ID field of the received frame. Thin solid lines indicate flows of the data transmitted when the node is designated in the second destination ID field of the received frame. Lower case alphabets added to the sides of the thick solid lines and the thin solid lines indicate the data of the nodes. The same frame is transmitted to the first destination and the second destination (frame is transmitted by broadcast or multicast), and the flows of the transmitted data are also the same in the first destination and the second destination.

The frame transmitted from the transmission node reaches all of the neighboring nodes (higher neighboring nodes and lower neighboring nodes), and the reception nodes designated in the first destination ID field and the second destination ID field execute reception processing. As a result, the transmission route of the data is duplicated. The reception node selects the data to be forwarded from the data field of the received frame according to one of the first destination ID field and the second destination ID field in which the node is designated. The reception node generates a frame in which the selected data is set in the data field and transmits the frame. In this way, although the reception nodes of the first destination and the second destination receive the same frame from the transmission node, the data selected and forwarded by the reception nodes are different. The magnitude of the data transmitted from each reception node is directly linked to the magnitude of the occupied wireless communication band.

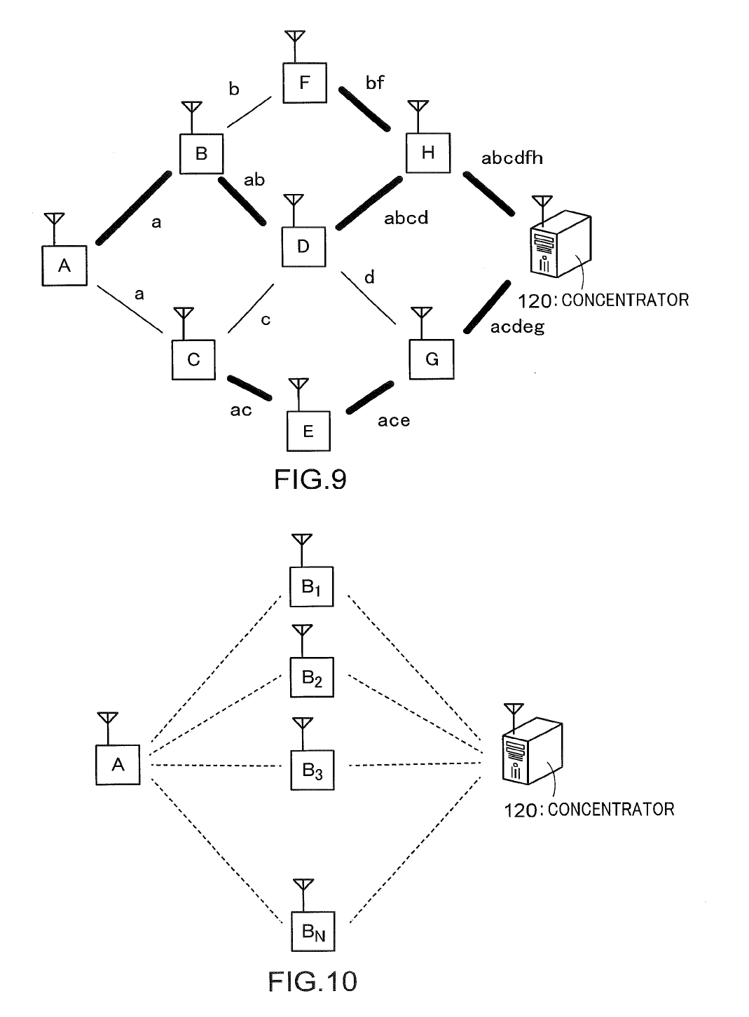

FIG. 9 is a diagram in which the alphabets of the data discarded (not forwarded) by the reception nodes are omitted from the alphabets added to the sides of the thin solid lines of FIG. 8. Differences between FIGS. 8 and 9 include the communication between the nodes C and D, the communication between the nodes D and G, and the communication between the nodes B and F. For example, it can be recognized that although the data “a” and “b” are transmitted in the communication between the nodes B and F, the data “a” is discarded by the node F.

Differences regarding the transmission reliability and the occupied band between the case in which the transmission route of the data is duplicated in this way and the case of the single route transmission and the flooding scheme will be described with reference to FIG. 10.

The transmission reliability will be described first. For the description, FIG. 10 shows a wireless multi-hop network including the node A belonging to the rank 2 and nodes B₁ to B_{N} belonging to the rank 1.

N corresponds to the number of nodes belonging to the rank 1. A success probability (connection probability) of direct communication between nodes is “p” (O<p≦1). The size of the band occupied by one datum is 1. The header and the like added to the data are ignored here for the simplification. In the single route transmission, the data “a” of the node A reaches the concentrator through one of the nodes of the rank 1. A transmission success probability in this case is The transmission success denotes that the data is normally received by the concentrator. The transmission success probability in the case of two routes is “1-(1-p²)²”, and the transmission success probability in the case of flooding is “1-(1-p²)^{N}”. When N is 2, the transmission success probabilities of the two-route transmission scheme and the flooding scheme are the same.

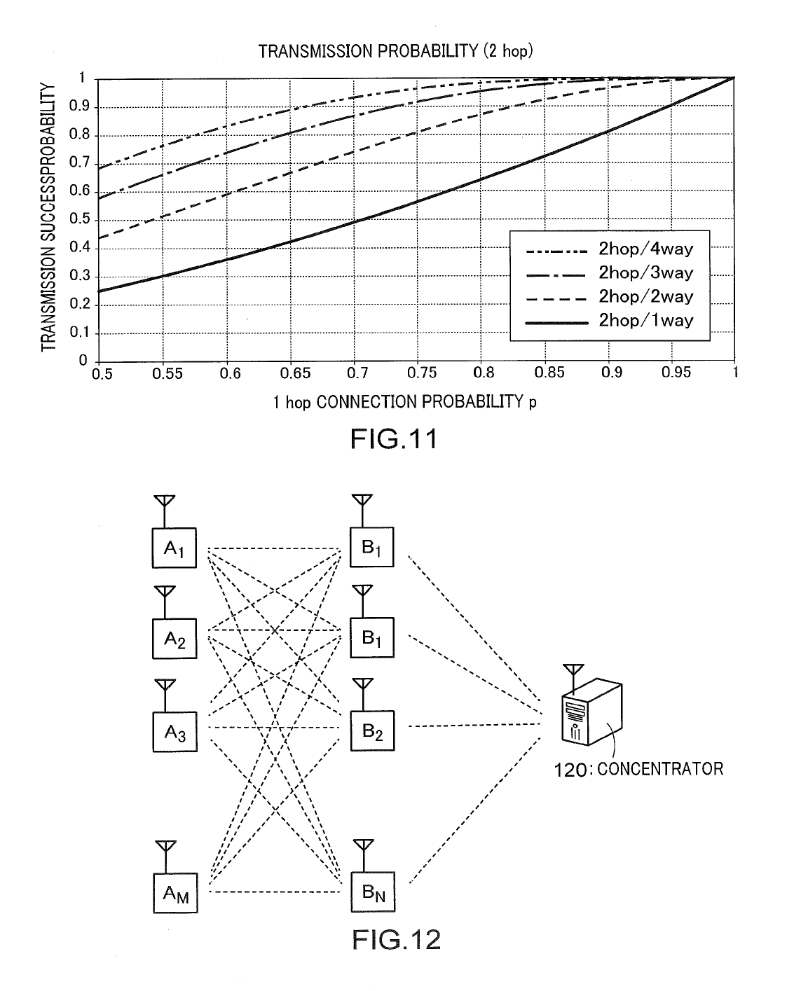

FIG. 11 shows an example of the transmission success probabilities in the single route transmission, the two-route transmission, and the flooding scheme. The flooding scheme corresponds to the case in which the number of nodes (the number of routes) is three or four. The transmission success probability improves with an increase in the number of routes, and therefore, the reliability improves. However, it can be recognized that when the success probability (connection probability) “p” of direct communication between nodes is high (for example, p=0.9), the reliability is not affected much even if the number of transmission routes increases to three or more.

Next, the occupied band will be described. For the description, a wireless multi-hop network as in FIG. 12 will be simulated. Nodes A₁ to A_{M} belonging to the rank 2 and the nodes B₁ to B_{N} belonging to the rank 1 are arranged. In addition to the sensor data of the node, each node transmits the data to be forwarded if the data exists. The data output by the nodes A₁ to A_{M} will be written as sensor data “a₁” to “aₘ”.

In all of the cases of single route, two routes, and flooding, the occupied band of uplink transmission between the nodes belonging to the rank 2 and the nodes belonging to the rank 1 is “M”. The occupied band of communication between the nodes belonging to the rank 1 and the concentrator is “M+N” in the case of single route, “2M+N” in the case of two routes, and “M×N” in the case of flooding. The orders of the amount of occupation are “O(N)”, “O(N)”, and “O(N²)”, respectively, and it can be recognized that the band occupation amount of flooding increases exponentially.

Therefore, the two-route transmission according to the present embodiment is better than the single route in terms of the transmission reliability and is better than the flooding in terms of the amount of occupied band. It can be recognized that the two-route transmission is a balanced transmission method.

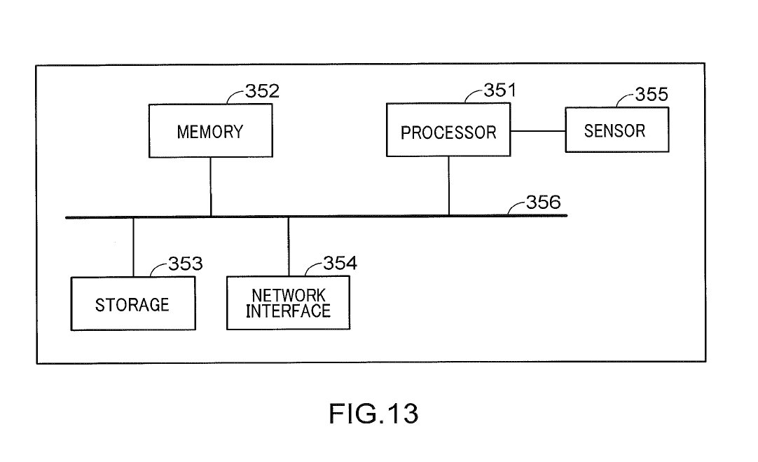

FIG. 13 is a block diagram showing an example of a hardware configuration of the wireless communication device according to an embodiment of the present invention. The wireless communication device includes a processor 351, a memory 352, a storage 353, a network interface 354, and a sensor 355 which are connected through a bus 356.

The processor 351 reads a program from the storage 353 and expands the program in the memory 352 to execute the program to thereby realize functions of the reception frame analyzer 302, the forward data selector 303, the transmission destination determiner 305, the measurement information acquirer 306, and the transmission frame creator 307. The processor 351 is connected to the sensor 355 and receives sensor data measured by the sensor 355. The processor 351 may control sensing timing of the sensor 355, such as sensing cycle of the sensor 355. The number of sensors 355 may be one or two or more.

The memory 352 temporarily stores a command executed by the processor 351, various data used by the processor 351, and the like. The memory 352 may be a volatile memory, such as an SRAM and a DRAM, or may be a non-volatile memory, such as a NAND and an MRAM. The storage 353 is a storage device configured to persistently store programs, data, and the like and is, for example, an HDD or an SSD. The database 304 is formed in one or both of the memory 352 and the storage 353. The sensor data acquired by the processor 351 is stored in one or both of the memory 352 and the storage 353. The frames received from other nodes may also be stored in one or both of the memory 352 and the storage 353.

The network interface 354 is an interface for performing wireless or wired communication and corresponds to the wireless communicator 301. The network interface 354 may include, for example, a baseband integrated circuit, an AD conversion circuit, and a DA conversion circuit configured to execute header processing of the data link layer, such as the MAC layer, and the physical layer and to perform modulation and demodulation and may include an RF integrated circuit configured to execute analog processing and the like. The analog processing includes frequency conversion, band control, amplification process, and the like between the baseband and the wireless frequency. A processor such as a CPU may be arranged on the network interface 354. When the TCP/IP or the like is used, the CPU on the network interface 354 may execute processing of the TCP/IP or the like, or the processor 351 connected to the bus 356 may execute the processing. Although only one network interface is illustrated here, a plurality of network interfaces, such as a wireless network interface and a wired network interface, may be mounted. The network interface 354 may be controlled by the processor 351, and the frames received from other nodes and frames transmitted to other nodes may be exchanged between the processor 351 and the nodes.

The network interface 354 may directly access the memory 352 by DMA (Direct Memory Access).

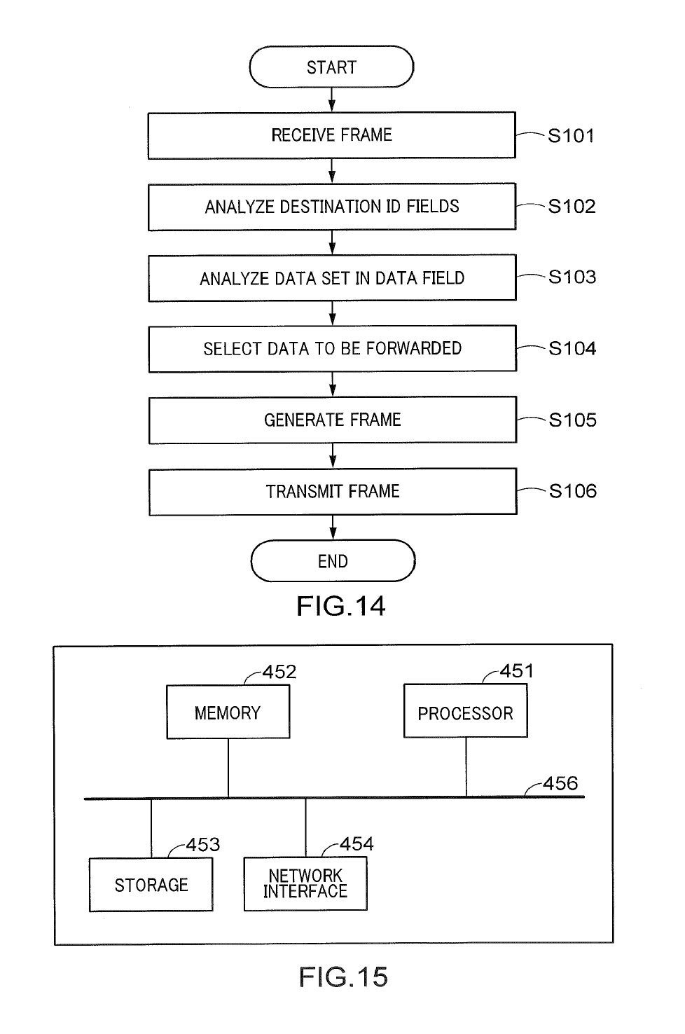

FIG. 14 is a flow chart of operation of the wireless communication device (node) according to the present embodiment. The wireless communicator 301 receives a frame from a lower adjacent node (S101). The frame includes the transmission source ID field, the first destination ID field, the second destination ID field, and the data field in which data related to other nodes is set.

The destination analyzer 311 of the reception frame analyzer 302 detects one of the first destination ID field and the second destination ID field in which the identifier of the node is set (S102).

The data analyzer 312 of the reception frame analyzer 302 analyzes the data included in the data field. More specifically, the data analyzer 312 checks the nodes for which the data is stored (S103).

The forward data selector 303 selects the data to be forwarded from the data included in the data field of the received frame according to the data selection condition related to the destination ID field in which the identifier of the node is set (S104). The selected data is stored in a storage device, such as a memory and a storage, at least until the start of the next time slot for transmission.

At the start of the time slot for transmission, the transmission frame creator 307 specifies the data to be transmitted in the time slot of this time from the storage device and adds the specified data to the data field. The transmission frame creator 307 also adds the data including the sensor data of the node acquired by the measurement information acquirer 306 to the data field. The transmission frame creator 307 sets the first destination (identifier) and the second destination (identifier) instructed from the transmission destination determiner 305 in the first destination ID field and the second destination ID field. The transmission frame creator 307 also sets the identifier of the node in the transmission source ID field. In this way, the transmission frame creator 307 generates the frame (S105).

The wireless communicator 301 transmits the frame created by the transmission frame creator 307 in the time slot allocated to the node (S106).

The transmission destination determiner 305 may determine the first destination and the second destination at an arbitrary stage in the middle of the operation of the flow or may periodically determine the first destination and the second destination separately from the operation of the flow. The measurement information acquirer 306 may acquire the sensor data at an arbitrary stage in the middle of the operation of the flow or may periodically acquire the sensor data separately from the flow of the operation. The order of the steps of FIG. 14 is an example, and the order is not limited to this.

FIG. 15 is a block diagram showing an example of a hardware configuration of the concentrator 120. In FIG. 15, the concentrator 120 includes a processor 451, a memory 452, a storage 453, and a network interface 454 which are connected through a bus 456.

The network interface 454 is an interface for performing wireless or wired communication with the nodes. The network interface 454 may include a baseband integrated circuit, an AD conversion circuit, and a DA conversion circuit configured to execute header processing of the data link layer, such as the MAC layer, and the physical layer and to perform modulation and demodulation and may include an RF integrated circuit configured to execute analog processing and the like. A processor such as a CPU may be arranged on the network interface 454. When the TCP/IP or the like is used, the CPU on the network interface 454 may execute processing of the TCP/IP or the like, or the processor 451 connected to the bus 456 may execute the processing. Although only one network interface is illustrated here, a plurality of network interfaces, such as a wireless network interface and a wired network interface, may be mounted. Communication with a server on the cloud may be performed through the network interface. The network interface 454 may be controlled by the processor 451. The network interface 454 may directly access the memory 452 by DMA (Direct Memory Access).

The memory 452 temporarily stores a command executed by the processor 451, various data used by the processor 451, and the like. The memory 452 may be a volatile memory, such as an SRAM and a DRAM, or may be a non-volatile memory, such as a NAND and an MRAM. The storage 453 is a storage device configured to persistently store programs, data, and the like and is, for example, an HDD or an SSD.

The processor 451 reads a program from the storage 453 and expands the program in the memory 452 to execute the program to thereby realize the function of the concentrator 120. For example, the processor 451 extracts the data from the data field of the frame received from the node and stores the data in the storage 453 or the memory 452. In this way, the processor 451 collects the data from each node. The concentrator 120 may upload the collected data to the cloud through a wire circuit and the like. The data collected by the concentrator 120 may be processed by an arbitrary method.

In the present embodiment, the first data selection condition requires to select all of the data included in the data field of the received frame, and the second data selection condition requires to select the data of the node of the transmission source (node designated in the transmission source ID field) from all of the data included in the data field of the received frame. In another example, the first data selection condition may require to select one of a plurality of groups formed by grouping the data included in the data field of the received frame according to the number of destinations (two here), and the second data selection condition may require to select another one of the plurality of groups. For example, data “abcdef” is set in the data field of the received frame. The data “abcdef” is grouped. A method of grouping is defined in advance or separately notified from a manager or the like to each node. The groups may be formed based on, for example, a ratio of the number of data. For example, the number of data is divided by a ratio of 2:1. In the present embodiment, “abcdef” is divided into two in the midway to obtain “abcd” and “ef”, for example. The data with a larger number of data is determined to be the first destination, and the data with a smaller number of data is determined to be the second destination. It is determined to forward “abcd” at the head to the first destination and to forward “ef” at the back to the second destination. Any example of grouping may be adopted, and other methods may be adopted. For example, the data of the node of the transmission source may always belong to the group forwarded to the first destination. Only part of the data (for example, data of the node of the transmission source) may be duplicated and belong to the groups.

Note that a network control form of the wireless multi-hop network according to the present embodiment may be arbitrary. For example, a distributed network may be adopted, in which individual nodes autonomously judge and determine the allocation of the paths, the routes, and the time slots in the network as well as the allocation of the frequency. Alternatively, a centralized control network may be adopted, in which a concentrator, a server, or the like comprehensively manages and determines these matters. In addition, a control form between the distributed type and the centralized control type can also be adopted, in which a group is formed by nodes positioned at a short distance, and paths are determined in the group.

According to the present embodiment, both of the transmission reliability and the saving of wireless band can be attained with a low power consumption.

### Second Embodiment

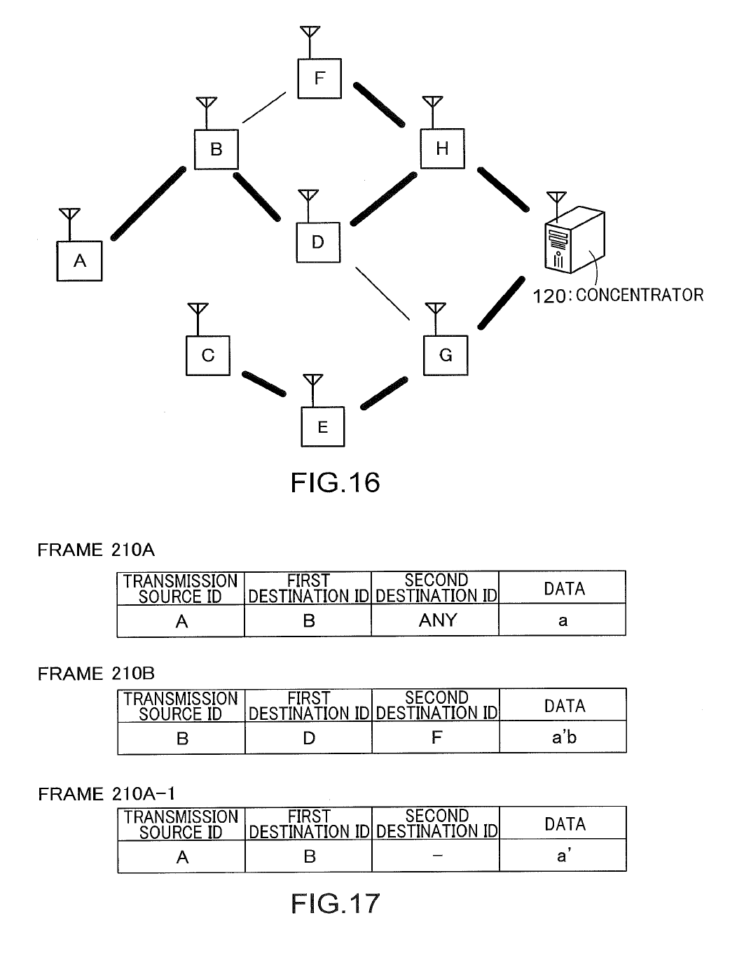

FIG. 16 shows an example of a wireless multi-hop network according to a second embodiment. In the example, the higher neighboring node of the node A is only the node B. According to the operation of the first embodiment, the node A designates the node B in the first destination ID field and does not designate a node in the second destination ID field. The node A sets the data of the node A in the data field and transmits the frame. The frame transmitted by the node A is not received by nodes other than the node B, and the data “a” of the node A is transmitted by a single route. In this case, the transmission reliability of the data “a” is reduced.

Therefore, in a first method of the present embodiment, the node sets an arbitrary wireless communication device, or more specifically, a value (ANY) indicating an arbitrary higher neighboring node, in the second destination ID field when there is no node to be designated in the second destination ID field. In the present example, there is no higher neighboring node other than the node B, and the node A sets the identifier of the node B in the first destination ID field and sets “ANY” in the second destination ID field. An upper row of FIG. 17 shows an example of a frame 210A transmitted by the node A.

Although the frame 210A is transmitted without expecting that the frame 210A reaches a higher neighboring node other than the first destination (B), a higher node (another node) other than the node B of the first destination may actually receive the frame 210A. When the other node (such as the node C in the example of FIG. 16) that has received the frame 210A confirms that “ANY” is set in the second destination ID field, the other node processes the frame 210A as in the case in which the identifier (C) of the node is set in the second destination ID field. In this way, the possibility of making the transmission route of the data of the node A redundant increases even if the node A does not designate the second destination.

In a second method, the node designated in the first destination ID field (node B in the frame 210A of FIG. 17) may duplicate the transmission route of the data “a” instead of the node A. More specifically, the node B sets, along with the data of the node B, the data “a” in the data field of the frame to be transmitted from the node when the node B confirms that the node B is designated in the first destination ID field of the frame 210A received from the node A and that “ANY” is set in the second destination ID field. In this case, forwarding instruction information is set for the data “a”. The forwarding instruction information instructs the node (node F in FIG. 17) designated in the second destination ID field to accept (forward) the data “a” instead of discarding the data “a”. A middle row of FIG. 17 shows an example of a frame 210B transmitted from the node B.

As shown in FIG. 17, the data “a” and “b” are set in the data field of the frame 210B, and a dash “′” as the forwarding instruction information is added to the data “a”. The dash “′” will be called a route redundancy request marker (hereinafter, referred to as a “marker”). The marker may be expressed in any form in the implementation of the program. For example, a bit (True/False) may be provided in an option field of data, and whether there is a marker may be expressed by ON/OFF of the bit. Alternatively, the marker may be added as an attribute or an element to JSON or XML data expressing the data. Alternatively, setting of the marker may be expressed by repeating the data twice and setting the data in the data field. For example, “aab” may be set in the data field to express the forwarding instruction information for “a”. Alternatively, a protocol may be provided such that the data described in part (for example, first half) of the frame is handled as data without the marker, and the data described in other part (for example, second half) of the frame is handled as data with the marker. Any format may be adopted.

The node D designated in the first destination ID field of the frame (middle row of FIG. 17) created by the, node B sets “a” and “b” set in the data field of the frame received frame node B and the data “d” of the node in the data field as in the first embodiment regardless of whether there is a marker, and the node D also sets the other fields to generate a frame. The node D transmits the frame to the nodes H and G that are higher neighboring nodes.

On the other hand, the node F designated in the second destination ID field of the frame created by the node B extracts the data “b” that is the data of the node B as the transmission source from the data field of the frame received from the node B, and the node F adds the data “b” to the data field of the frame along with the data of the node F. The node F also adds the data “a” provided with the marker to the data field of the frame. As a result of the operation, the data “a” is transmitted through a single route up to the node B, but the data “a” is transmitted through two routes by the nodes D and F after the node B. The reduction in the reliability can be avoided.

In a third method, the node A may transmit a frame 210A-1 shown in a lower row of FIG. 17 instead of the frame 210A shown in the upper row of FIG. 17. The node A designates no value in the second destination ID field instead of “ANY”. On the other hand, the node A sets the data “a” in the data field and provides the marker to the data “a”. When the node B that has received the frame 210A-1 detects that the identifier is set only in the first destination ID field and nothing is set in the second destination ID field and detects that the marker is provided to the data “a”, the node B performs the same operation as when the frame 210A of the upper row of FIG. 17 is received.

Although the marker can be used to duplicate the transmission route of the data from a single route, the transmission route can also be made redundant by forming three or more routes. In this case, the number of destination ID fields can also be three or more, and an integer count value, such as 3 and 4, can be provided as a marker.

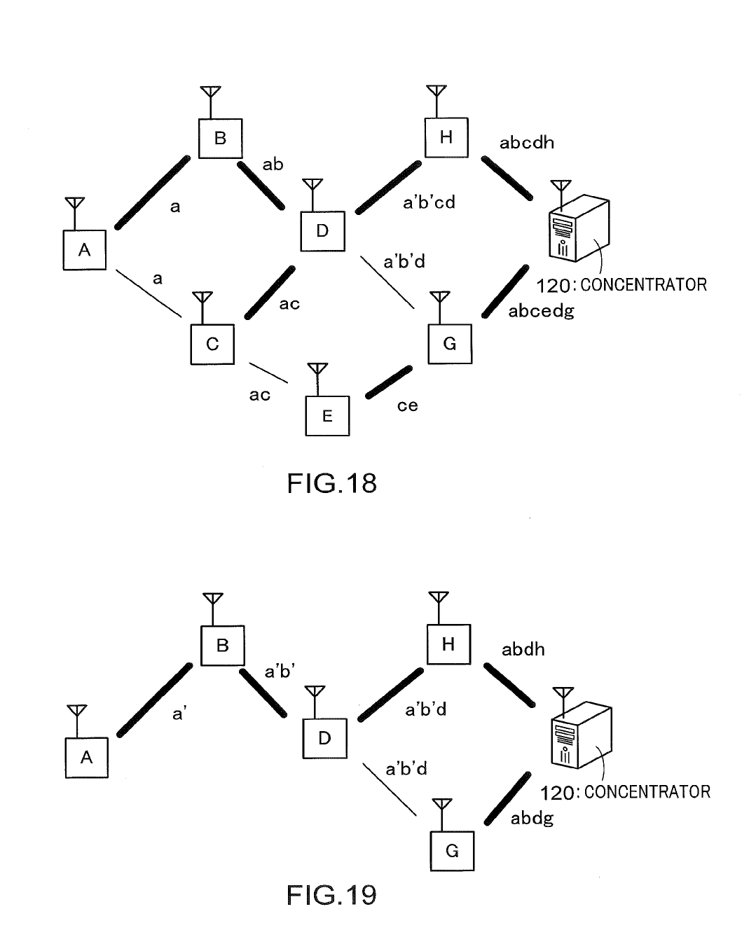

FIG. 18 shows another example of data transmission in the wireless multi-hop network according to the second embodiment. The example illustrates a case in which the duplicated data gathers at one node. For example, the data “a” duplicated and transmitted from the node A gathers at one node D.

When the node detects that the same data gathers at the node, the node adds the marker to the same data and forwards the data. For example, when the node D detects that the data “a” gathers at the node D, the node D adds the marker to “a” and forwards the data “a”. As a result, the data “a” temporarily gathered at the node D is duplicated again from the node D.

In the example of FIG. 18, the node C selects the node D as the first destination and selects the node E as the second destination. When the node C figures out the path configuration (such as the first destination and the second destination of each node) of the entire network or among the surrounding nodes, the node C may select the node E as the first destination and select the node D as the second destination to avoid gathering of the data “a” at the node D. The gathering can also be similarly avoided when the path configuration is determined by central control by the concentrator or the like. However, an appropriate path setting (such as determining the first destination and the second destination) is not always possible when, for example, each node determines the first destination and the second destination in an autonomous distributed manner. Therefore, when the same data gathers at the same node, the operation described above can prevent subsequent formation of a single route to avoid the reduction in the reliability.

FIG. 19 shows yet another example of the data transmission in the wireless multi-hop network according to the second embodiment. FIG. 19 shows a situation in which although a node receives data with the marker, the node cannot duplicate the data because there is no candidate for the second destination in the node. In the example of FIG. 19, although the node B receives the data “a” with the marker from the node A (for example, see the frame 210A-1 of the lower row of FIG. 17), there is no candidate for the second destination in the node B. In such a case, the node adds the marker to the data again and transmits the data. In the example of FIG. 19, the node B adds the marker to the data “a” again. In this case, the marker may also be added to the data B for the data “b” of the node B as in the third method described with reference to FIG. 17. In this way, the node B sets the data in the data field after adding the markers to the data “a” and the data “b” and transmits the frame.

### Third Embodiment

Although two transmission routes can be secured to improve the reliability of transmission in the first and second embodiments, this is only for the nodes in the rank 2 or below.

The nodes of the rank 1 directly communicate with the concentrator. Therefore, the transmission route is not made redundant, and the reliability of transmission does not improve. The present embodiment provides means for increasing the reliability of transmission of the nodes in the rank 1.

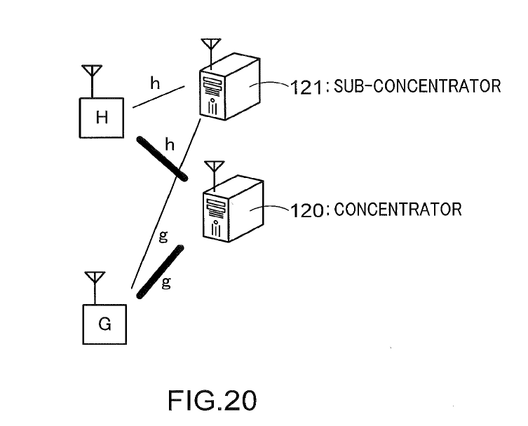

FIG. 20 shows an example of arranging a sub-concentrator in the wireless multi-hop network in addition to the concentrator. The sub-concentrator has a function of communicating with the nodes to collect the data just like the concentrator. The nodes H and G are nodes of the rank 1, and the nodes of the rank 2 and below are not illustrated.

For example, the node of the rank 1 designates the concentrator 120 as the first destination of the frame and designates a sub-concentrator 121 as the second destination in order to increase the reliability of transmission of the node in the rank 1.

In another example of configuration, the sub-concentrator 121 may collect the data included in the data field of the frame regardless of the content in the second ID field of the received frame.

The concentrator 120 and the sub-concentrator 121 may accumulate the collected data in the storage. The data may be uploaded to the cloud through wire circuits or the like. The data collected by the concentrator and the sub-concentrator may be processed by an arbitrary method.

In another example of, configuration, the nodes of the rank 1 may transmit the same frame for a plurality of times. When the TDMA (see FIG. 3) is used in the wireless multi-hop network, more power can be saved by shifting the nodes and the concentrator to a sleep state in time slots other than the time slots for transmitting and receiving the data. Here, when the concentrator can obtain stable power from a power supply through a wire, the concentrator may be enabled to always communicate, and communication at times other than the time slots may be used to surely transfer the data of the node of the rank 1 to the concentrator. For example, ACK/NACK and retransmission may be carried out, and CSMA/CA and the like may be carried out at times other than the time slots.

For example, the node of the rank 1 may transmit the frame in the time slot and may retransmit the frame based on CSMA/CA or the like if the node determines that the transmission of the frame has failed according to a reply status of ACK/NACK. Specifically, the node may transmit the frame in the time slot of the node and may receive the ACK/NACK. When the retransmission is necessary, the node may use the CSMA/CA in the same period (period 1 of FIG. 3) as the period including the time slot, or in another period (such as periods 2 to 4), to retransmit the frame and receive the ACK/NACK. When the length of the time slot is a length sufficient for receiving the ACK/NACK for the transmission of the frame, the node may perform both of the transmission of the frame in the time slot of the node and the reception of the ACK/NACK. The node can shift to the sleep state after checking that the frame is normally received.

### Fourth Embodiment

Although the TDMA is mainly used as a communication scheme in the wireless multi-hop network in the first to third embodiments, the communication scheme to be used is not limited to this. For example, the TDMA and the CSMA may be used together.

A case will be simulated in which part of the nodes in the network are operated and driven by batteries, and the rest of the nodes are connected to power supplies capable of stable supply of power through wires. The power supply may be a utility power supply or may be a power supply mounted on the node and capable of generating power by natural energy such as solar light. There is no need or a little need for the node (stable power supply node) capable of receiving the supply of power from the stable power supply to sleep. Therefore, the neighboring node (such as a node in the next higher or lower rank) of the stable power supply mode may transmit the frame to the stable power supply node at an arbitrary timing regardless of the allocation of the time slot. However, CSMA/CA, CSMA/CD (Collision Detect), or the like may be carried out to avoid collision of transmission timing with other nodes.

### Fifth Embodiment

In the first to fourth embodiments, the transmission route is mainly duplicated to improve the reliability of transmission. However, sufficient reliability may not be obtained in a node of a low rank, i.e. a node far from the concentrator, even if the transmission route is duplicated.

Therefore, third and subsequent destination ID fields or the like can be added as options to the frame to triplicate or further multiplex the transmission route. Thus, whether to form three or more routes is judged, and if it is determined to form three or more routes, the third and subsequent destination ID fields may be set to form three or more routes. The node designated in the third destination ID field may perform the same operation as when the node is designated in the second destination ID field, or other operation may be defined.

Each node may judge whether to form three or more routes, or when there is a separate manager configured to manage the nodes, the manager may judge whether to form three or more routes. In the latter case, the manager can transmit a judgement result indicating the number of transmission routes or the like to each node. The concentrator 120 may also serve as the manager.

For the judgement, an evaluation function with parameters including a value of the rank that the node belongs, the RSSI of the route in the midway, and the like may be used. For example, RSSIs of the higher neighboring node as the first destination and the higher neighboring node as the second destination may be compared with a threshold, and if one or both of the RSSIs are lower than the threshold, another higher neighboring node may be designated as the third destination. If there are only two higher neighboring nodes, and the third higher neighboring node cannot be designated, “ANY” may be designated in the third destination ID field. Note that “ANY” may be designated in the third destination ID field even if there is another higher neighboring node. The threshold of the RSSI may vary between the higher neighboring node as the first destination and the higher neighboring node as the second destination. For the RSSI, the reception power in the neighboring node for which the data is transmitted from the node may be used, or the reception power in the node that receives the data from the neighboring node may be used. A statistic, such as an average of these, may also be used.

### Sixth Embodiment

Although a plurality of destinations (first to N-th (N is an integer equal to or greater than 2) destinations) are set in the frame in the first to fifth embodiments, the identifiers of the destinations and the data selection conditions of the frames can be notified in advance to the neighboring nodes as the forwarding destinations to omit some or all of the destination ID fields from the frame.

For example, the node transmits in advance a frame (destination notification frame) for notifying the data selection condition of the frame (for example, second data selection condition) to the higher neighboring node that is the transmission destination, separately from the transmission of the frame including the data. The neighboring node that has received the notification associates the identifier of the node of the transmission source of the destination notification frame with the data selection condition notified to the node and stores the associated data. When the higher neighboring node is changed, the node transmits the destination notification frame according to the higher neighboring node after the change. For the higher neighboring node removed from the transmission destination, the node notifies the removal in the destination notification frame. As a result, when the frame is received from the node, the neighboring node can specify the data selection condition applied by the neighboring node from the identifier set in the transmission source ID field of the frame and from the associated data and perform operation according to the specified data selection condition (whether the identifier of the node is set in any of the destination ID fields does not have to be checked). Note that the destination notification frame may include information related to at least one of a remaining battery of the node, power generated by energy harvesting (when a power generator is provided), a predicted amount of power, integrity, and a trouble, in addition to the data selection condition.

Although the selection of the higher neighboring node may change according to the radio wave condition, the frequency of change in the selection of the higher neighboring node can be low in a network with a small change in the radio wave propagation environment. Therefore, the transmission frequency of the destination notification frame can also be low, and the traffic of the entire network can be reduced by omitting the destination ID field to reduce the frame length.

The destination notification frame is exchanged between the nodes to share the destination relationship between the nodes, and the node basically does not have to receive the frames in advance from the nodes other than the nodes designating the node. Therefore, the node may be shifted to a power saving state (sleep state) at times other than the times scheduled to receive in advance the frames from the nodes designating the node. However, the node and the neighboring node need to be able to communicate with each other (activated) at the exchange timing of the destination notification frame.

### Seventh Embodiment

In the first to sixth embodiments, the frame is transmitted by broadcast or multicast based on a predetermined communication protocol. More specifically, the destinations based on the wireless communication protocol of the frame transmitted by broadcast or multicast are all of the nodes in the same network. After executing the reception process of the frame, the node that has received the frame acquires the message including the transmission source ID field, the first destination ID field, the second destination ID field, and the data field. The node executes processing to determine whether the node is designated in the first destination ID or second destination ID field shown in FIG. 7 and performs operation accordingly.

Here, the frame may be transmitted by unicast instead of the broadcast or the multicast. When the unicast is used, frames with different payload data are generated and transmitted for the first destination and the second destination. For example, for the first destination, a frame is generated by setting all of the content of the data field of the received frame and the data of the node in the data field. In this case, the identifier of the first destination is set in at least one of the first destination ID field and the second destination ID field of the frame. A value may not be set in the other field, or an arbitrary value may be set. On the other hand, for the second destination, a frame is generated by selecting the data of the node of the transmission source ID from the data included in the data field of the received frame and adding the selected data and the data of the node to the data field. In this case, the identifier of the second destination is set in at least one of the first destination ID field and the second destination ID field of the frame. A value may not be set in the other field, or an arbitrary value may be set. An example of a method of unicast transmission includes setting unicast addresses (MAC addresses) of the nodes of the first destination and the second destination as destination addresses (such as MAC addresses) based on the wireless communication protocol of the frames transmitted to the first destination and the second destination.

Regardless of whether the node is designated in the first destination ID field or the second destination ID field, the reception node that has received the frame of the unicast copies all of the content of the data field of the received frame to the data field of the frame transmitted from the node if the node is designated in one of the first destination ID field and the second destination ID field. The node further adds the data including the sensor data of the node to the data field and transmits the frame. As for the format of the frame in the unicast transmission, a field storing only the ID of the destination node may be set in place of the first destination ID field and the second destination ID field. In this case, the reception node can check that the identifier of the node is set in the field.

An antenna with no directivity or a weak directivity is basically used in the transmission in the wireless communication in the wireless multi-hop network of each embodiment. However, when an antenna with a directivity is used in the wireless communication, particularly when an antenna capable of controlling the directivity is used, the directivity of the transmission node may be changed according to the node of the transmission destination. Similarly, the directivity of the reception node may be changed according to the node that is the transmission source. By setting the directivity of the radio wave only between the nodes transmitting and receiving the data, unicast communication can be realized while setting the destination address of the wireless communication protocol of the frame to a broadcast or multicast address.

When the radio wave propagation status between the node and the higher neighboring node for which the data is to be transmitted is preferable, the communication is possible even if the transmission power of the wireless communication is reduced. Therefore, the transmission power may be reduced in such a case. The same applies to the reception, and the gain of an amplifier, such as an LNA (Low-Noise Amplifier) configured to amplify a received signal, may be reduced if the radio wave propagation status is preferable. Appropriate reception is also possible in this way.

The directivity can be controlled to reduce the transmission and reception power in a specific direction. Controlling the directivity and the transmission and reception power allows the node not to receive unnecessary frames and allows the other nodes not to receive unnecessary frames. An example of the antenna with directivity includes a dipole antenna. A shielding object or a reflection object can be intentionally arranged near the antenna to change the propagation characteristics.

To control the directivity of the antenna, an actuator or the like may rotate, move, and deform the antenna or one of the shielding object and the radio wave reflection object around the antenna. An electric switch may be used to switch an antenna to be used among a plurality of antennas. An electric switch may be used to change the radio wave characteristics of the antenna or the object that is a reflection object of the radio wave. MIMO (Multi-Input and Multi-Output) transmission using a plurality of antennas may also be performed. A medium other than the radio wave can also be used as a transmission medium, and in that case, the directivity and the like can be controlled as in the case of the radio wave. For example, the directivity largely changes in sound wave communication or visible light communication depending on shapes and frequencies of speakers and luminous instruments. Any of the media can be used to realize the embodiments.

Note that the node may also include a wire communicator in addition to the wireless communication device. The node may include a plurality of antennas corresponding to a plurality of frequency bands and may use or switch the plurality of antennas at the same time to perform wireless communication. The wireless communication device and the wire communicator may be switched according to the node that is the transmission destination. The antenna to be used may be switched according to the node that is the transmission destination. When the frequency bands of a plurality of nodes that are transmission destinations are different, a plurality of antennas with different frequency bands may be used to transmit the frames at the same time.

An individual key set for each pair of two nodes may be used to encrypt the messages (for example, transmission source ID field, first and second destination ID fields, and data field) set in arbitrary fields in the frame. In this way, the other nodes cannot decode the messages of the frame even if the nodes receive the frame, and a communication similar to the unicast can be substantially realized. In this case, when there are two or more destinations for the node, the same individual key may be used between the node and the destinations.

In the communication based on the TDMA (time-division scheme), the communication cannot be correctly performed unless the transmission node and the reception node execute the transmission process and wait for the reception in the same time slot. Therefore, a set of nodes that can communicate can be controlled by the manner the time slots are allocated, for example. When a plurality of different frequency channels or bands are used, the set of the nodes that can communicate can be similarly controlled by the manner the frequency channels to be used are allocated. There is also a method called TSCH (Time Slotted Channel Hopping) with a combination of allocation of time slots and allocation of frequencies, and the method can also be used.

Although the description so far is mainly based on the wireless communication using radio waves, the embodiments can also be applied to wireless communication other than radio waves, such as a communicator using sound waves and visible light. The present embodiment can also be realized by wired communication, such as Ethernet (TM), coaxial cable, and PLC (Power Line Communication), or by a virtual space, such as a computer program.

The wireless sensor network in the specific examples of the wireless multi-hop network according to the embodiments includes any networks from an outdoor large-scale network to an indoor relatively small-scale network. The sensor node used in the network uses a battery or energy harvesting as a power supply in the operation, and the sensor measures various data, such as temperature, humidity, acceleration, infrared (motion sensor), illumination, color, weight, distortion, and sound. The measured sensor data is often temporarily aggregated to the aggregator (concentrator) by using wireless communication, wired communication, or other communicators. Part of the sensor data may be transmitted by wireless communication, and the rest of the sensor data may be transmitted by wired communication. The aggregator saves the collected sensor data or transmits the sensor data to a higher system such as a cloud server. Depending on the form of the network, the sensor data may be directly transmitted to the cloud server or the like without the involvement of the aggregator.

One or both of an actuator and a display incorporated into the network may feedback the sensor data to the real world. The sensor data can also be used for human trajectory, prediction of disaster, analysis of aging of infrastructure facilities, such as bridges, roads, and tunnels, weather forecast, and the like.

One or both of the aggregator and the higher system can transmit data to the sensor node, and optimal route information, allocation information of time slot, a sensing cycle command, and the like may be exchanged. In this case, the sensor node determines the first destination, the second destination, and the like based on the optimal route information. The sensor node determines the time slot of the terminal and figures out the sensing time of the sensor and the like.

In addition to the sensor nodes, the network may include a node for relay not provided with the sensor. In addition to the concentrator, the network may include a backup node and the like configured to sniff packets to record and retain data. It is obvious that the present embodiments can be applied not only to the wireless sensor network, but also to any wireless networks constructed by using wireless communication techniques, such as wireless LAN, Wi-Fi (R), Bluetooth (R),

ZigBee (R), and IEEE 802.15.4 (R).

The terms used in each embodiment should be interpreted broadly. For example, the term “processor” may encompass a general purpose processor, a central processing unit (CPU), a microprocessor, a digital signal processor (DSP), a controller, a microcontroller, a state machine, and so on. According to circumstances, a “processor” may refer to an application specific integrated circuit (ASIC), a field programmable gate array (FPGA), and a programmable logic device (PLD), etc. The term “processor” may refer to a combination of processing devices such as a plurality of microprocessors, a combination of a DSP and a microprocessor, or one or more microprocessors in conjunction with a DSP core.

As another example, the term “memory” may encompass any electronic component which can store electronic information.

The “memory” may refer to various types of media such as a random access memory (RAM), a read-only memory (ROM), a programmable read-only memory (PROM), an erasable programmable read only memory (EPROM), an electrically erasable PROM (EEPROM), a non-volatile random access memory (NVRAM), a flash memory, and a magnetic or optical data storage, which are readable by a processor. It can be said that the memory electronically communicates with a processor if the processor read and/or write information for the memory. The memory may be arranged within a processor and also in this case, it can be said that the memory electronically communication with the processor. The term “circuitry” may refer to not only electric circuits or a system of circuits used in a device but also a single electric circuit or a part of the single electric circuit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A wireless communication device comprising:
a receiver configured to receive a first frame having first to M-th destination ID fields related to first to M-th data selection conditions and a data field, the data field including first to N-th data related to first to N-th wireless communication devices wherein M is an integer equal to or greater than 2 and N is an integer equal to or greater than 1;
processing circuitry configured to select at least one of the first to N-th data based on the data selection condition related to the destination ID field including an identifier of the self-wireless communication device among the first to M-th destination ID fields and create a second frame having a data field including the data selected; and
a transmitter configured to transmit the second frame.

2. The wireless communication device according to claim 1, wherein
the first data selection condition requires to select all of the first to N-th data in the data field of the first frame, and
the second data selection condition requires to select the data related to a wireless communication device of a transmission source of the first frame among the first to N-th data in the data field of the first frame.

3. The wireless communication device according to claim 2, wherein
the first frame includes forwarding instruction information set for at least one data of the first to N-th data, and
the second data selection condition requires to select, among the first to N-th data, the data related to the wireless communication device of the transmission source of the first frame and the data specified by the forwarding instruction information.

4. The wireless communication device according to claim 1, wherein
the first to M-th data selection conditions require to select one of a plurality of groups, the groups including different data of the first to N-th data in the first data field,
the processing circuitry selects the group from the plurality of groups based on the data selection condition, and
the processing circuitry sets all of the data belonging to the selected group in the data field of the second frame.

5. The wireless communication device according to claim 1, wherein
the processing circuitry collectively sets, in the data field of the second frame, data selected for a plurality of the first frames received in a certain period.

6. The wireless communication device according to claim 1, wherein
the processing circuitry collectively sets, in the data field of the second frame, data selected for a plurality of first frames received in a certain period,
when the data fields of the plurality of first frames commonly include same data, the frame creator sets forwarding instruction information for the same data,
the second frame includes first to M-th destination ID fields related to the first to M-th data selection conditions, and
the second data selection condition requires to select, from the data in the data field of the second frame, the data related to a wireless communication device of a transmission source of the second frame and the data specified by the forwarding instruction information.

7. The wireless communication device according to claim 1, wherein
the processing circuitry being configured to acquire data,
the processing circuitry further sets the data acquired by the data acquirer in the data field of the second frame,
the processing circuitry sets forwarding instruction information for the data acquired by the data acquirer among the data in the data field of the second frame,
the second frame includes first to M-th destination ID fields related to the first to M-th data selection conditions, and
the second data selection condition requires to select, from the data in the data field of the second frame, the data related to a wireless communication device of a transmission source of the second frame and the data specified by the forwarding instruction information.

8. The wireless communication device according to claim 1, wherein
the second frame includes first to M-th destination ID fields related to the first to M-th data selection conditions, and
the processing circuitry sets a value indicating any wireless communication device in at least one of the first to M-th destination fields.

9. The wireless communication device according to claim 1, wherein
the first data selection condition requires to select all of the first to N-th data in the data field of the first frame,
the second data selection condition requires to select, from the first to N-th data in the data field of the first frame, the data related to a wireless communication device of a transmission source of the first frame and the data specified by forwarding instruction information which is set for the data in the first frame, and
when an identifier of the self-wireless communication device is set in the first destination ID field related to the first data selection condition in the first frame, and a value indicating any wireless communication device is set in the second destination ID field related to the second data selection condition in the first frame, the forwarding instruction information is set for the data corresponding to the wireless communication device of the transmission source of the first frame among the data in the data field of the second frame.

10. The wireless communication device according to claim 1, wherein
the receiver receives a third frame designating a data selection condition for a frame whose transmission source is a specific wireless communication device, and
when a transmission source of the first frame is the specific wireless communication device, the processing circuitry selects the data from the first to N-th data based on the data selection condition designated by the third frame regardless of values in the first to M-th destination ID fields.

11. The wireless communication device according to claim 10, wherein
the processing circuitry ignores existence of the first to M-th destination ID fields and determines to use the data selection condition designated by the third frame.

12. The wireless communication device according to claim 1, wherein
the transmitter transmits the second frame by broadcast or multicast.

13. The wireless communication device according to claim 1, wherein
the processing circuitry creates a fourth frame and a fifth frame, the fourth frame being the second frame in which the first to N-th data are set in the data field and the fifth frame being the second frame in which the data corresponding to a wireless communication device of a transmission source of the first frame among the first to N-th data is set in the data field,
the transmitter transmits the fourth frame to a first transmission destination wireless communication device by unicast and transmits the fifth frame to a second transmission destination wireless communication device different from the first transmission destination wireless communication device by unicast, and
the M is equal to or greater than 1.

14. The wireless communication device according to claim 1, wherein
the wireless communication device is one of the plurality of wireless communication devices in a wireless multi-hop network comprising a plurality of wireless communication devices and an aggregator, the wireless communication devices being configured to aggregate, to the aggregator, data of the wireless communication devices in relaying between the wireless communication devices, the wireless communication device which is the one of the plurality of wireless communication devices being capable of directly communicating with the aggregator,
a transmission destination of the second frame is the aggregator, and
the transmitter transmits the second frame for a plurality of number of times.

15. A wireless communication system comprising:
a plurality of wireless communication devices; and
an aggregator, wherein
the plurality of wireless communication devices is the wireless communication device according to claim 1, respectively, and
data of the wireless communication devices is relayed between the plurality of wireless communication devices and aggregated to the aggregator.

16. A wireless communication method comprising:
receiving a first frame having first to M-th destination ID fields related to first to M-th data selection conditions and a data field, the data field including first to N-th data related to first to N-th wireless communication devices wherein M is an integer equal to or greater than 2 and N is an integer equal to or greater than 1;
selecting at least one of the first to N-th data based on the data selection condition related to the destination ID field including an identifier of the self-device among the first to M-th destination ID fields;
a frame creator configured to create a second frame having a data field including the data selected; and
a transmitter configured to transmit the second frame.

17. A non-transitory computer readable medium, having a program stored therein which when executed by a computer, causes the computer to perform processing of steps comprising:
receiving a first frame having first to M-th destination ID fields related to first to M-th data selection conditions and a data field, the data field including first to N-th data related to first to N-th wireless communication devices wherein M is an integer equal to or greater than 2 and N is an integer equal to or greater than 1;
selecting at least one of the first to N-th data based on the data selection condition related to the destination ID field including an identifier of the self-device among the first to M-th destination ID fields;
creating a second frame having a data field including the data selected; and
transmitting the second frame.
